(19) United States
(12) Patent Application Publication
(10) Pub. No.: US 2010/0332077 A1
(43) Pub. Date: Dec. 30, 2010

(54) WIRELESS WINCH SWITCH

(75) Inventors: Todd Hanson, Loretto, MN (US); Michael Hamm, Maple Grove, MN (US); Siva Iyer, Plymouth, MN (US)

Correspondence Address: HONEYWELL/IFL;Patent Services, 101 Columbia Road, P.O.Box 2245, Morristown, NJ, 07962-2245, US

(73) Assignee: Honeywell International Inc.

(21) Appl. No.: 12/492,803

(22) Filed: Jun. 26, 2009

(51) Int. Cl. G06F 7/00

(52) U.S. Cl. 701/36

(57) ABSTRACT

A wireless winch switch system has a removable switch module that is removably retained by a receptacle. The removable switch module has a rechargeable power source and wireless communications module that transmits a winch control signal based on the position of a switch. Control circuitry receives the winch control signal and controls a winch. The receptacle is mounted to a vehicle and obtains energy from a power source such as the vehicle's battery. The removable switch module can obtain the energy from the receptacle and thereby charge the rechargeable battery.

### TECHNICAL FIELD

Embodiments are generally related to switching systems for controlling a winch mounted on a vehicle. Embodiments are also related to wireless remote control techniques for controlling winches.

### BACKGROUND OF THE INVENTION

Winches may be mounted on a vehicle in order to assist a vehicle operator in manipulating large objects. For example, winches may be utilized to maneuver trailers, vehicles, or other heavy loads into position for towing or on-board transport.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is therefore an aspect of the embodiments that a vehicle such as an all terrain vehicle has a winch, winch control circuitry, and a receptacle for a removable switch module. The receptacle has a mechanism that retains the switch module such that the removable switch module can be retained by the receptacle and can be released from the receptacle.

It is a further aspect of the embodiments that the removable switch module has a switch, a wireless communications module, and a rechargeable power source. The rechargeable power source can power the removable switch module when it is not retained by the receptacle. Furthermore, the rechargeable power source can be a battery, capacitor, or any other rechargeable energy storage means. The switch has a number of positions or states corresponding to winch movements such as wind, unwind, and do nothing. The wireless communications module transmits a winch control signal based on the switch position. The winch control circuitry can receive the control signal and control the winch accordingly.

The receptacle has charging circuitry that can recharge the rechargeable power source when the removable switch module is close enough. For example, the receptacle and the wireless switch module can both have conductive contacts that touch when the removable switch module is retained in the receptacle. In this case, a direct electrical connection is formed for recharging the rechargeable power source. Additionally, the control signal can be passed through the touching conductive contacts. In another example, inductive, capacitive, or near field power transmission techniques remove the need for conductive contacts while still providing for charging the rechargeable power source.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a wireless winch switch in accordance with aspects of some embodiments; and

FIG. 2 illustrates a winch control system with a wireless winch switch in accordance with aspects of some embodiments.

### DETAILED DESCRIPTION

The particular values and configurations discussed in these non-limiting examples can be varied and are cited merely to illustrate at least one embodiment and are not intended to limit the scope thereof.

A wireless winch switch system has a removable switch module that is removably retained by a receptacle. The removable switch module has a rechargeable power source and a wireless communications module that transmits a winch control signal based on the position of a switch. Winch control circuitry receives the winch control signal and controls a winch. The receptacle is mounted to a vehicle and obtains energy from a power source such as the vehicle's battery. The removable switch module can obtain the energy from the receptacle and thereby charge the rechargeable battery.

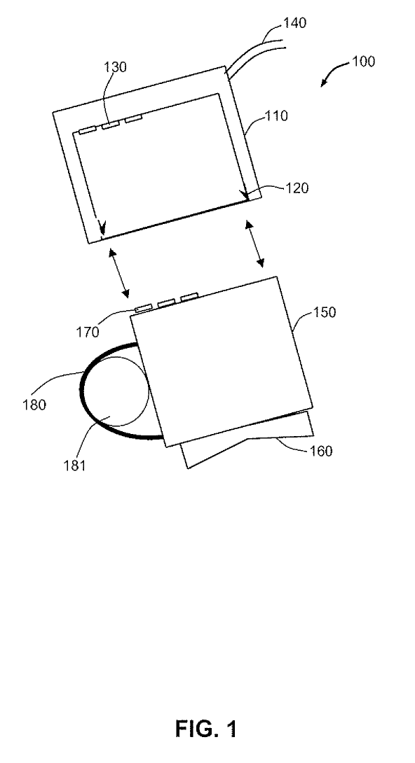

FIG. 1 illustrates a perspective view of a wireless winch switch system 100 in accordance with aspects of some embodiments. The wireless winch switch system 100 generally includes a switch receptacle 110 that releasably retains a removable switch module 150. As illustrated, locking tabs 120 can lock the switch module into the switch receptacle although other retention means can be used. The receptacle 110 can also include electrical contacts 130 that mate with a similar set of electrical contacts 170 on the switch module 150. A wiring harness 140 can supply power to the switch receptacle 110 which can then supply power through the electrical contacts 130, 170 to the removable switch module 150. The removable switch module 150 can originate a winch control signal that is passed through the electrical contacts 130, 170, and then to the winch control circuitry.

The winch control circuitry can be incorporated into the switch receptacle 110 or can be positioned elsewhere. In any case, the winch control circuitry receives the winch control signal and controls the winch. For example, if the winch control signal is “wind” then the winch control circuitry can cause the winch to turn and wind in a cable, rope, or other some other type of tether. Similarly, an “unwind” signal can cause the winch to turn and unwind the cable, rope, or other type of tether. The wiring harness 140 can carry the control signal from the switch receptacle 110 to the winch control circuitry if necessary although some embodiments wirelessly transmit the winch control signal.

A switch 160 in the switch module 150 can determine which, if any, winch control signal is sent. For example, the switch 160 can be a rocker switch having three positions: wind, unwind, and center. A “wind” winch control signal can be sent when the switch 160 is pressed to the wind position. An “unwind” winch control signal can be sent when the switch 160 is pressed to the unwind position. No winch control signal results when the switch 160 is centered. The switch 160 can have a return to center mechanism, such as spring loading, so that the switch 160 moves to the center position unless the switch 160 is actually being pressed into another position. In this case the center position is the default position. Some embodiments can also include mechanisms for locking the switch 160 in position. As such, the switch 160 can be locked into the center position to prevent unintended operation. Similarly, the switch can be locked into another position to free the operator's hands.

A strap harness 180 can be used to attach the switch module to a fixture 181. A fixture is, essentially, anything that the strap harness can fit around. For example, the switch module can be strapped to a tree, vehicle, or even a person.

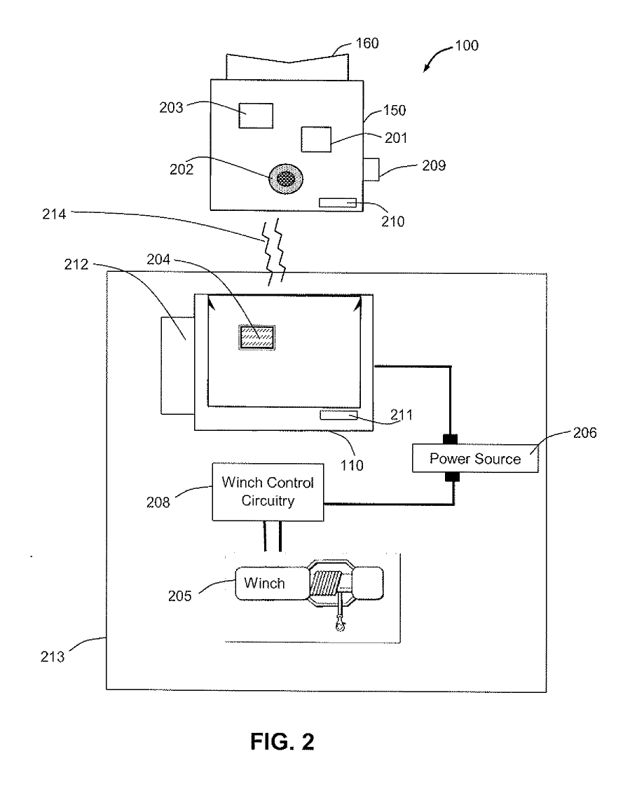

FIG. 2 illustrates a winch control system with a wireless winch switch 150 in accordance with aspects of some embodiments. Note that in FIGS. 1-2 identical or similar elements are generally indicated by identical reference numerals. The switch receptacle 110 is electrically connected to a power source 206, such as a vehicle battery or alternator as is winch control circuitry 208. In addition, the switch receptacle 110 is attached to the handlebar 212 of the vehicle 213 which can be an all terrain vehicle (ATV) or similar recreational vehicle. The winch control circuitry 208 controls a winch 205.

The switch receptacle 110 can incorporate a power transmitter 211 that can wirelessly transmit energy to a power receiver 210 in the switch module 150. There are a number of suitable technologies for wirelessly transmitting energy such as inductive coupling, capacitive coupling, and, near field coupling. Recalling the exemplary embodiment illustrated in FIG. 1, an alternative to wireless energy transmission is to directly pass the energy to the removable switch module 150 through wires and electrical contacts. The removable switch module can include a rechargeable power source 201 such as a rechargeable battery, capacitor, or super capacitor. Placing the power receiver 210 suitably close to the power transmitter 211 can result in powering the switch module 150 and recharging the power source 201. In general, power can be transmitted when the removable switch module 150 is close to the receptacle such as when it is retained in the switch receptacle 110.

The embodiment illustrated in FIG. 2 wirelessly transmits all power and control signals 214. For example, the winch control signals 214 are wirelessly transmitted from a wireless communications module 203 directly to the winch control circuitry 208. Contrast this with the embodiment illustrated in FIG. 1 where power and control signals are passed through wires and electrical contacts whenever the removable switch module 150 is retained in the switch receptacle 110.

The removable switch module can be lost or misplaced. For example, an ATV having a remotely operable winch 205 can become stuck in mud or a ditch. The driver can free the ATV by unwinding the winch cable, attaching it to a tree or other fixture, and then remotely operating the winch 205. The driver can stand clear of the tree, ATV, and cable while remotely operating the winch 205. The driver can also misplace the removable winch switch 150. The driver can find the removable winch switch 150 by activating a locator module 204 that can transmit a locator signal to the removable switch module 150. The removable switch module 150 activates a location indicator 202 upon receiving the locator signal. The location indicator 202 can emit light, sound, or both to assist the driver in finding the removable switch module 150.

The removable switch module 150 can include a light switch 209 that controls a light source such as a light emitting diode that is powered by the rechargeable power source 201. In the illustrative example, the location indicator 202 has a light source that serves as both a location aid and a light. Activating the locator module 204 causes the location indicator 202 to emit light. In addition, manipulating the light switch 209 can also cause the location indicator 202 to illuminate. Another embodiment can have a light source that is not part of the location indicator 202 and can therefore be used for illumination and not location indication. In any case, the removable switch module can also serve as a rechargeable flashlight.

The removable switch module 150 can have a weatherproof housing. For example, the entire unit, except for the winch switch 160 which in many embodiments must be free to move, can be completely encapsulated in plastic or resin and thereby be nearly impervious to the elements. Furthermore, the switch 160 itself can be a two piece switch with a moveable part, such as a rocker, and an encapsulated part. The moveable part can contain magnets such that moving the moveable part causes the encapsulated part to change state such that wind or unwind signal are produced.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a vehicle comprising a winch, winch control circuitry, and a receptacle for a removable switch module;
wherein the removable switch module comprises a switch, a wireless communications module that transmits a winch control signal based on a state of the switch, and a rechargeable power source that powers the wireless communication module;
wherein the receptacle comprises a locking mechanism that releasably retains the removable switch module, and charging circuitry that provides power from a power source of the vehicle to the rechargeable power source when the removable switch module is retained in the receptacle; and
wherein the winch control circuitry receives the winch control signal and controls the winch based on the received winch control signal.

2. The system of claim 1 wherein the switch has a plurality of positions comprising a default position at which the switch remains absent an applied force that holds the switch in another one of the plurality of positions.

3. The system of claim 1 further comprising a locator module that when activated transmits a locator signal to the switch module wherein the switch module further comprises a location indicator that is activated when the switch module receives the locator signal.

4. The system of claim 3 wherein the location indicator produces a sound when activated.

5. The system of claim 3 wherein the location indicator emits light when activated.

6. The system of claim 1 wherein the switch module further comprises a strap harness for strapping the switch module to an object to thereby attach the switch module to the object.

7. The system of claim 1 wherein the switch module comprises a weatherproof housing.

8. The system of claim 1 wherein an ATV comprises the power source and the winch.

9. The system of claim 8 wherein the ATV further comprises a handlebar to which the receptacle is fixed.

10. The system of claim 1 wherein the removable switch module further comprises a light source and a light switch.

11. A system comprising:
winch control circuitry that receives a winch control signal and controls a winch based on the received control signal; and
a vehicle comprising the winch and a receptacle for a removable switch module;
wherein the removable switch module comprises a switch, a wireless communications module that transmits the control signal based on a state of the switch, and a rechargeable power source that powers the wireless communications module; and
wherein the receptacle comprises a locking mechanism that releasably retains the removable switch module, and charging circuitry that obtains energy from a vehicle power source and provides the energy to the rechargeable power source to thereby charge the rechargeable power source.

12. The system of claim 11 wherein the charging circuitry provides power to the rechargeable power source through a direct electrical connection.

13. The system of claim 11 wherein locking the removable switch module to the receptacle produces an electrical connection for wired operation of the winch.

14. The system of claim 11 further comprising a locator module that when activated causes a location indicator to activate and thereby indicate the location of the switch module.

15. The system of claim 14 wherein the removable switch module comprises the location indicator.

16. A system comprising:
winch control circuitry that receives a winch control signal and controls a winch based on the received control signal; and
a vehicle comprising the winch and a receptacle for a removable switch module;
wherein the removable switch module comprises a switch, a wireless communications module that transmits the control signal based on a state of the switch, a rechargeable power source that powers the wireless communications module, a light switch, and a light source controlled by the light switch; and
wherein the receptacle comprises a locking mechanism that releasably retains the removable switch module, and charging circuitry that obtains energy from a vehicle power source and provides the energy to the rechargeable power source to thereby charge the rechargeable power source.

17. The system of claim 16 wherein the charging circuitry wirelessly transmits energy that recharges the rechargeable power source.

18. The system of claim 16 further comprising a locator module that when activated causes a location indicator to activate and thereby indicate where the switch module is located.

19. The system of claim 18 wherein the location indicator comprises the light source.

20. The system of claim 16 wherein the switch module further comprises a strap harness for strapping the switch module to a fixture.
